(19) United States
(12) Patent Application Publication
(10) Pub. No.: US 2024/0372337 A1
(43) Pub. Date: Nov. 7, 2024

(54) SYSTEMS, DEVICES, ARTICLES, AND METHODS FOR IMPROVED SAFETY AT ELECTRICAL PANELS

(71) Applicant: Christopher Vincent Busto, Burnaby (CA)

(72) Inventor: Christopher Vincent Busto, Burnaby (CA)

(21) Appl. No.: 18/652,737

(22) Filed: May 1, 2024

Related U.S. Application Data
(60) Provisional application No. 63/499,687, filed on May 2, 2023.

(51) Int. Cl. H02B 1/14; H01B 3/30; H01B 17/40; H02B 1/052

(52) U.S. Cl. CPC H02B 1/14; H01B 3/30; H01B 17/40; H02B 1/052

(57) ABSTRACT

An insert for an electrical panel including an insulative block including a first edge, second edge, a pair of sides, a first end, and a second end. The insert further includes at least one void defined in the insulative block extending from the second edge into the insulative block.

### TECHNICAL FIELD

The invention generally relates to breaker panels used to distribute electricity to a plurality of circuits through circuit breakers.

### BACKGROUND

The purpose of the following description of related art is solely to provide background information about the relevant field of the disclosure. It should be noted that this section is only to enhance the understanding of the reader concerning the present disclosure. Therefore, unless otherwise indicated, it should not be assumed that any of the information described in this section qualifies as prior art merely by their inclusion in this section.

Circuit breaker panels are used to distribute electricity to a plurality of circuits plus accommodate circuit breakers that disengage one or more of these circuits under unsafe conditions, such as overloading, overheating, or short-circuiting. Circuit breaker panels are extendable in that an electrician can add more breakers until the panel is full or fill it to the maximum allowed based on their safety standards for electrical installations.

### SUMMARY

This section is intended to introduce certain objectives and aspects of the disclosure in a simplified manner. The disclosure relates to an insert for an electrical panel including an insulative block including a first edge, second edge, a pair of sides, a first end, and a second end. The insert further includes at least one void defined in the insulative block extending from the second end into the insulative block. In some embodiments, the void is one of a groove, a first set of jaws, or a hole.

An insert for an electrical panel including a first arm, a second arm, and a trunk coupling the top arm and the bottom arm. The insert further includes a first edge, a second edge, a pair of sides, an end, and an inner face. The first edge defines part of the first arm, and the second edge defines part of the second arm. The inner face defines part of the first arm, the second arm, and the trunk. The insert further includes a groove that extends from the end into the trunk and to the second edge.

An electrical product including an electrical panel, and at least one insert described herein.

This summary does not necessarily describe the entire scope of all aspects. Other aspects, features, and advantages will be apparent to those of ordinary skill in the art upon review of the following description of specific embodiments.

### BRIEF DESCRIPTION OF THE DRAWINGS

These and other features, aspects, and advantages of the invention will become better understood when the following detailed description is read with reference to the accompanying drawings in which like characters represent like parts throughout the drawings, wherein:

FIG. 1 is a perspective view of an electrical panel including a panel cover.

FIG. 2 is a top-rear isometric view of a first insert in accordance with various aspects of the invention.

FIG. 3 is a bottom-front isometric view of the first insert.

FIG. 4 is a side view of the first insert.

FIG. 5 is a bottom-front isometric view of a second insert in accordance with various aspects of the invention.

FIG. 6 is a top-front isometric view of the second insert.

FIG. 7 is a top-rear isometric view of a third insert in accordance with various aspects of the invention.

FIG. 8 is an elevation view of the third insert.

FIG. 9 is a top-front isometric view of a fourth insert.

FIG. 10 is a top-front isometric view of a fifth insert.

FIG. 11 is a bottom-front isometric view of the fifth insert.

FIG. 12 is a side view of a sixth insert.

The above-mentioned drawings illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component.

### DETAILED DESCRIPTION

In the following description, associated drawings included claims, and other parts of the document, various details are set forth to provide a detailed understanding of the disclosure and embodiments thereof. It will be apparent, however, that the disclosed embodiments may be practiced without these details. Several features described hereafter can each be used independently of one another or with any combination of other features.

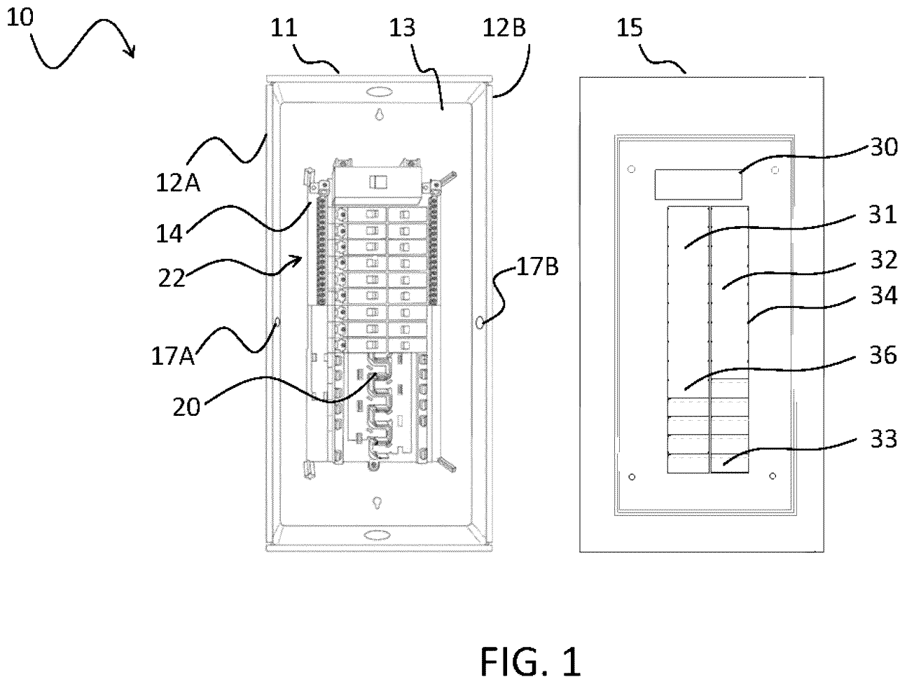

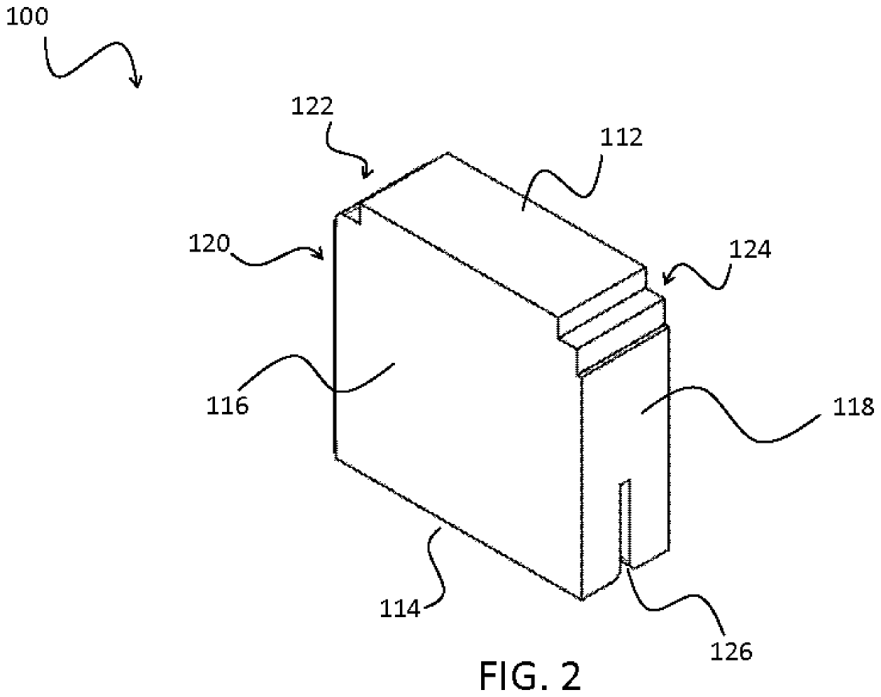

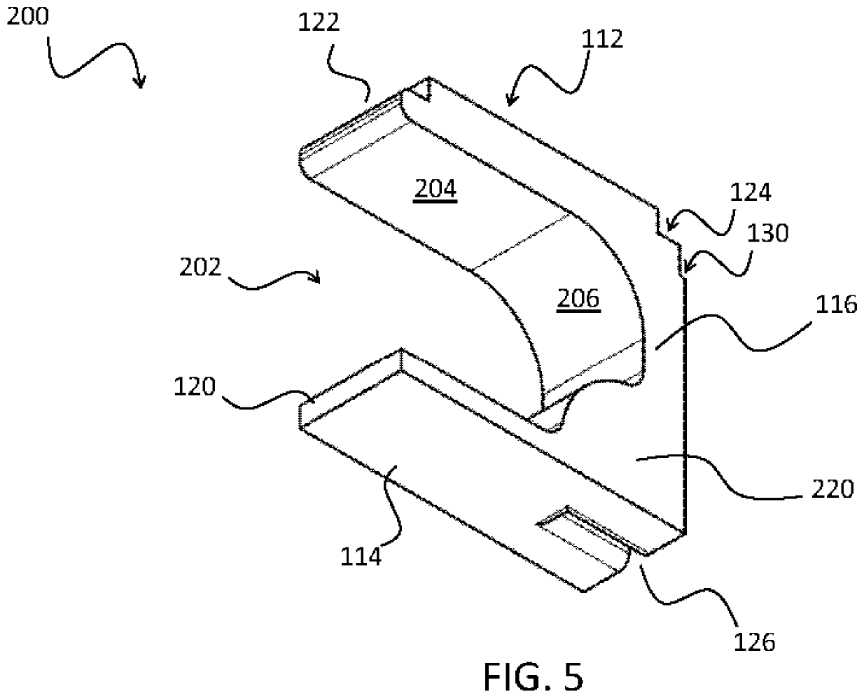

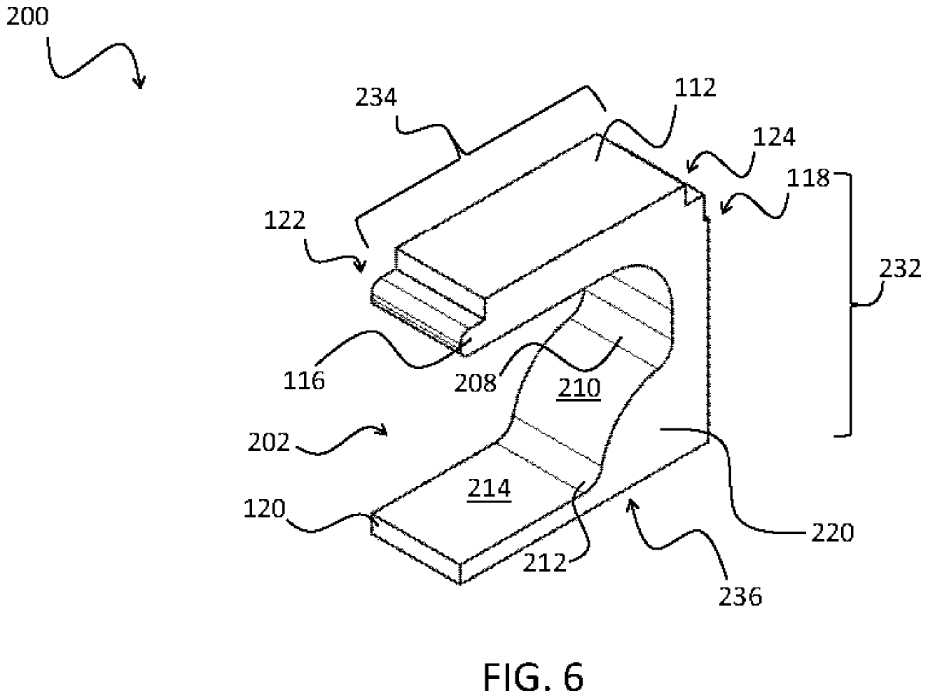

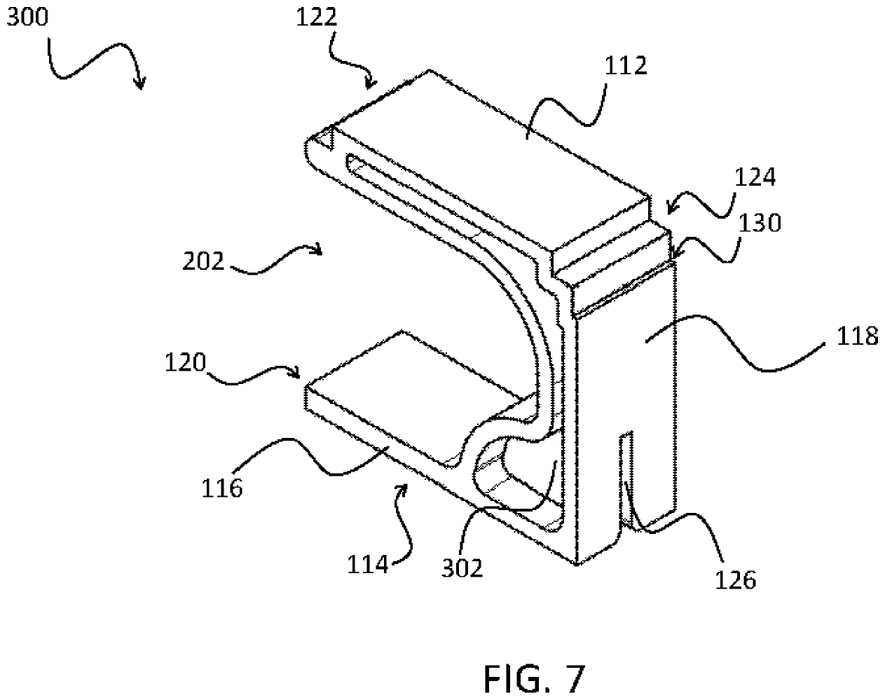

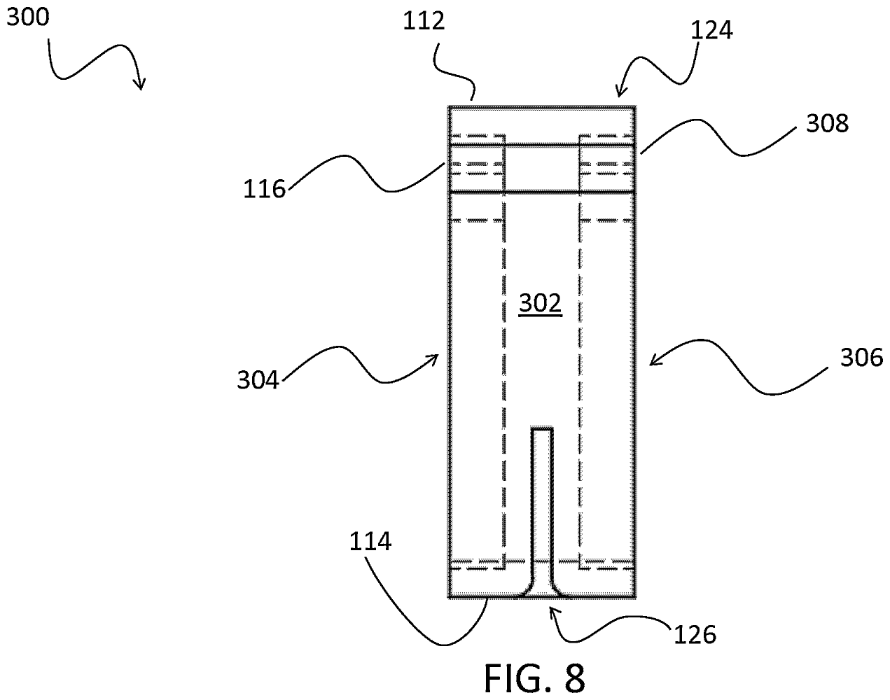

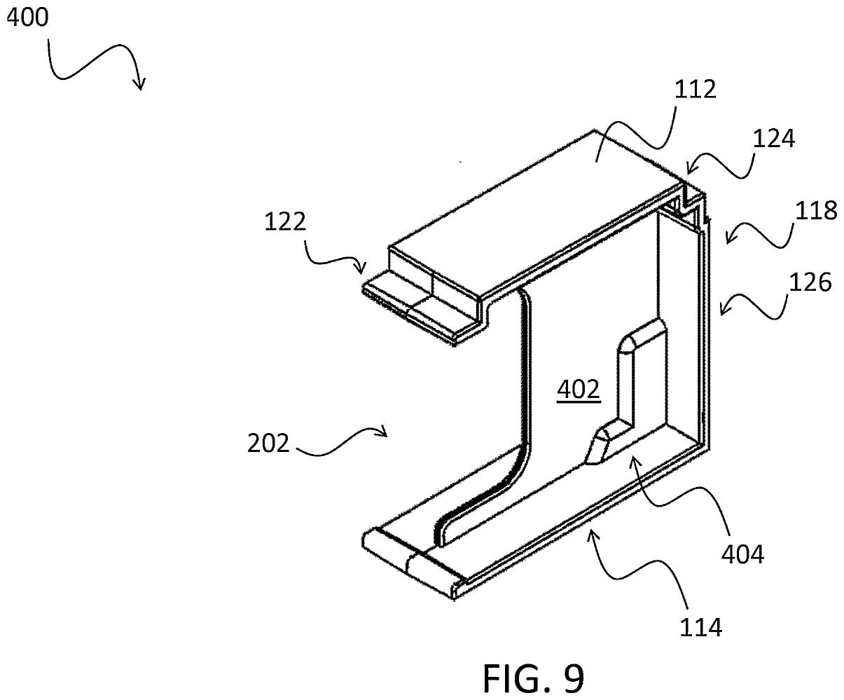

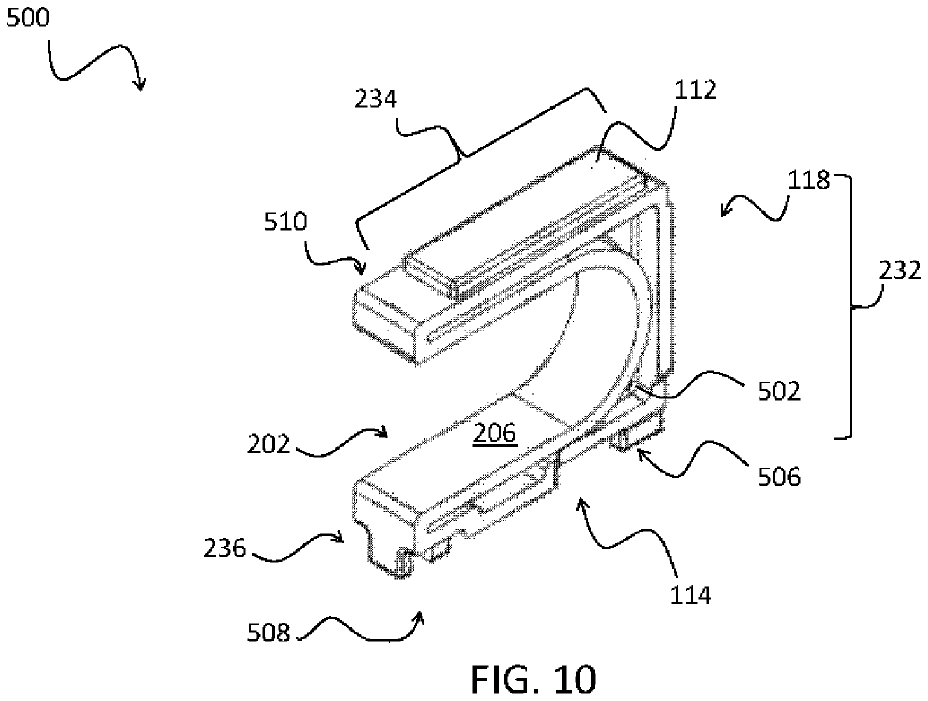

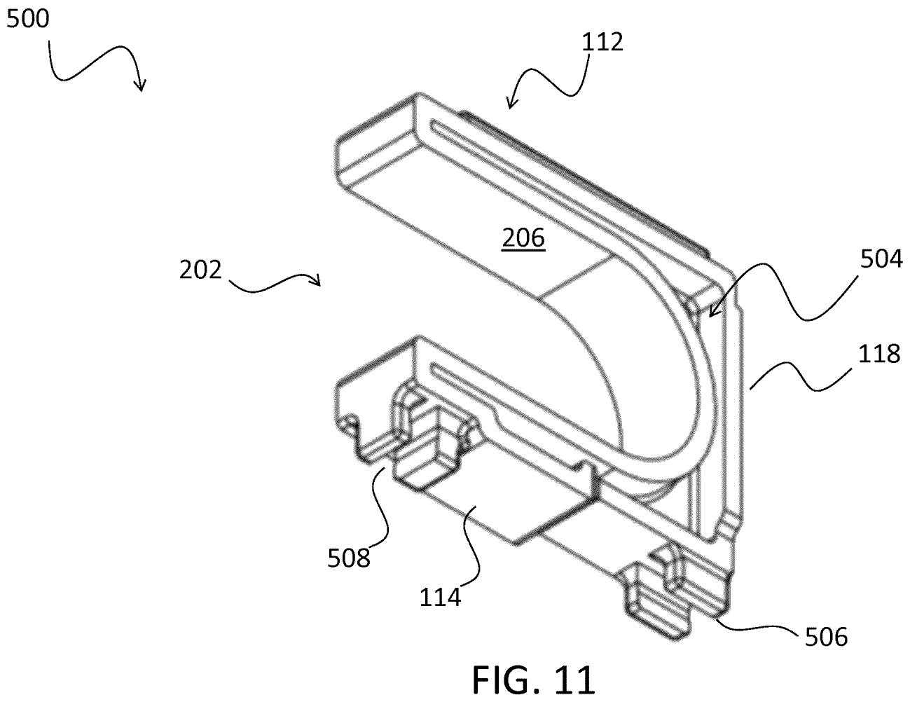

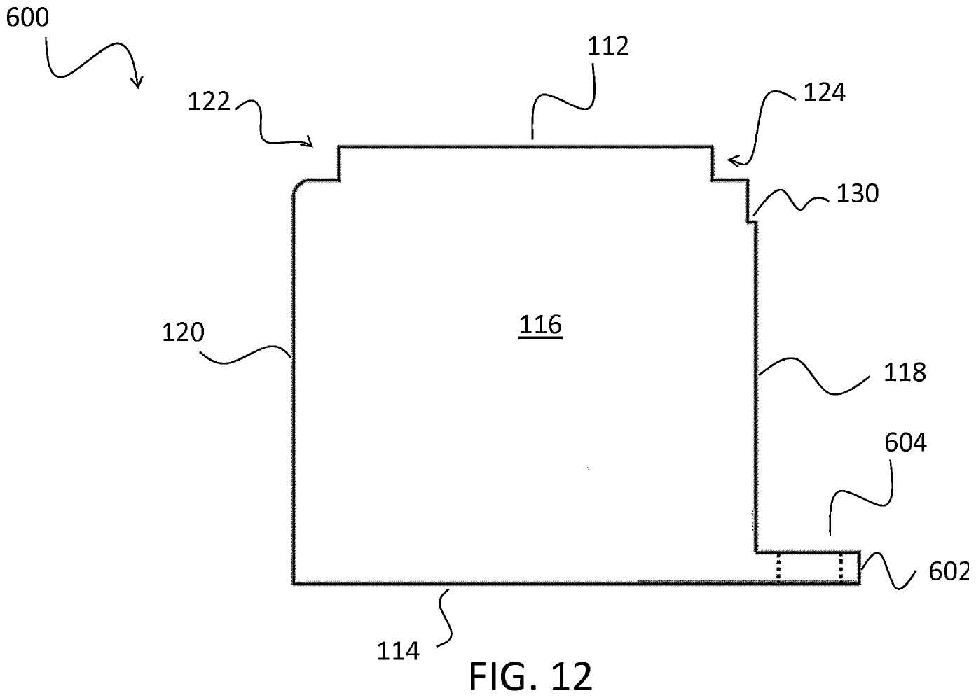

Hence, the Applicant appreciates there is a need for an efficient insert to overcome problems with the commercially available filler plates presently used in electrical panels as shown in FIG. 1. Further, FIGS. 2 to 4 show the first example of an insert for use in an electrical panel. FIGS. 5 and 6 show a second example of an insert. FIGS. 7 and 8 show a third example. FIG. 9 shows a fourth example. FIGS. 10 and 11 show a fifth example. FIG. 12 shows a sixth example. In operation, the first, second, third, fourth and fifth examples are a stab on component while the sixth is a bolt on component. Aspects, including common aspects, of all illustrated examples plus others are described herein.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

Unless otherwise indicated, all numbers expressing feature sizes, amounts, and physical properties used in the specification and claims are to be understood as being modified in all instances by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein. For example, depending on the choice of a measurement technique, a length of 2 inches may include a variation of about 1%, which would indicate length may be about 1.98 inches to about 2.02 inches.

The definitions provided herein are to facilitate understanding of certain terms used frequently herein and are not meant to limit the scope of the present disclosure.

A “bus bar” refers to one or more electrically coupled electrical conductors used to distribute AC or DC power to a plurality of circuit breakers. To carry large amounts of current bus bars are often made of a highly conductive metal such as copper or aluminum. An electrical panel includes one or more bus bars.

A “knock-out” or “knockout” is a frangible (e.g., partially stamped) part in electrical enclosures that can be opened (e.g., knocked out) that allows quick entry of a wire, cable, or pipe by a connector or fitting to the interior. A “panel cover twistout” is a frangible part of an electrical panel cover that may be removed by impact (e.g., snapped) or more commonly by twisting.

FIG. 1 shows an exemplary electrical panel 10 comprising a metal enclosure 11 including a plurality of side walls 12 and a back wall 13, and a bus bar support 14 (e.g., an electrically non-conductive body). As shown enclosure 11 is generally rectangular in shape and further includes a front wall or a panel cover 15. An electrical panel 10 may also include a door (not shown) in front of panel cover 15. FIG. 1 is a partially exploded view with panel cover 15 removed from enclosure 11 and placed to the side. Electrical panel 10 includes a bus bar 20. As shown, a plurality of breakers 22 overlie the bus bar support 14 and bus bar 20.

One or more parts of enclosure 11 include knockouts-frangible parts that if removed provide access to electrical panel 10 such as the interior. Examples of knockouts include knockout 17A on side wall 12A in the plurality of side walls 12. Typically, an electrician would remove knockouts like knockout 17A for installing conduit, cable, sheathed cable, and the like. A type of knockout for electrical panels in general and this disclosure is panel cover twistouts. Electrical panel 10 includes a plurality of panel cover twistouts (e.g., twistout 33) on panel cover 15.

Panel cover 15 includes one or more holes such as a first hole 30 for the main breaker. These may be, as shown in a recessed part of panel cover 15 to allow a door to close over the breakers with levers sitting proud of panel cover 15. As shown, panel cover 15 includes a first slot 31 comprising a first plurality of twistouts removed, and second slot 32 comprising a second plurality of twistouts removed. An intact twistout is shown at twistout 33. The twistouts include slugs joined to panel cover 15 by frangible tabs, e.g., tab 34. A superfluous or extra twistout was removed creating gap 36.

It is possible to remove more panel cover twistouts than are needed leaving a user with access to live parts of the panel such as a hot bus bar, e.g., bus bar 20. There is a risk of injury or death. An opening, such as gap 36, allows for foreign matter such as dirt and dust to enter which can have undesirable mechanical and electrical effects. One can buy filler plates (not shown) that would fill empty spaces normally filled by a twistout and prevent access to empty circuit breaker spaces behind the front wall. Commercially available filler plates are easy to break or lose; hard to set. and hard to keep in place, that is, the filler plates are finicky. Such filler plates do not provide any protection of and from the bus bar if the panel cover has been removed.

The present invention is related to an insert for an electrical panel that overcomes the above-mentioned problems. FIG. 2 is a top rear isometric view of the insert of the invention, generally depicted by numeral 100. Insert 100 has a generally rectangular or block shape and includes a plurality of surfaces such as a top edge 112, a bottom edge 114, two side faces including a (left) side face 116, a rear end 118, and a front end 120. The edges, ends, and faces can be collectively called surfaces. In keeping with front-rear and top-bottom directions the front end 120 and rear end 118 are substantially coplanar with the coronal plane, while top edge 112 and bottom edge 114 are substantially coplanar with the transverse plane. The median or sagittal plane lies between the two side faces. Insert 100 includes a first corner between the front end 120 and the top edge 112, a first step 122 is provided. In some embodiments, at a second corner between the top edge 112 and the rear end 118, is a second step 124.

Insert 100 further comprises at least one void defined in the insulative block extending from the second edge into the insulative block. In some embodiments, insert 100 further comprises at least one slot or groove 126 defined by a plurality of surfaces. The at least one groove 126 extends in a plane that is coplanar with the side faces (e.g., side face 116). In some embodiments, at least one groove 126 extends along the sagittal plane. In some embodiments, at least one groove 126 extends along the parasagittal plane. At least one groove 126 extends from rear end 118 and bottom edge 114 toward the center of insert 100.

In some embodiments, at least one groove 126 is located and extends from about the middle of rear end 118. In some implementations, at least one groove 126 is located and extends from the rear portion of bottom edge 114—that is, posterior to the coronal plane. At least one groove 126 may be located about the center of both bottom edge 114 and rear end 118. In some embodiment, at least one groove 126 extends into the insulative block from the middle of the second end to a part of the second edge near the second end and is coplanar with the pair of sides.

In some embodiments, Insert 100 further comprises a tab extending from an arris between the second end and second edge, and a hole defined in the tab.

Insert 100 is designed in such a way with suitable dimensions and mechanical properties that at least one groove 126 engages with a bus bar on an electrical panel. For example, at least one groove 126 engages with bus bar 20 shown in FIG. 1. The at least one groove 126 has a suitable depth into the interior or insert 100 that allows for insertion of a suitable body into at least one groove 126 such as bus bar 20 with an interference fit. The at least one groove 126 is sized so that in use insert 100 can be inserted or ejected from a breaker panel whenever the necessity arises.

In some embodiments, Insert 100 comprises a first side cavity in the insulative block at first side of the pair of sides, and a second side cavity in the insulative block at second side of the pair of sides, wherein the first side cavity, the second side cavity, the first edge, the second edge, and the second end define a flange profile; and the first side void, the second side void, and the pair of sides define a web profile.

Returning to first step 122 and second step 124. First step 122 includes a riser that in some implementations is coplanar with the front end 120. In some embodiments, step 122 includes a tread coplanar with the top edge 112. In some implementations, second step 124 includes a tread coplanar with the top edge 112. In some embodiments, second step 124 includes a tread that is coplanar with the rear end 118. The first step 122 and second step 124 may include one or more treads and one or more risers. In the exemplary embodiment shown in FIG. 2, first step 122 includes one step—that is, one tread and one riser. In the shown embodiment, second step 124 includes two treads and two risers. The treads and risers in first step 122 may be the same or different in number and size to those in second step 124.

In some embodiments, second step 124 includes a lower tread and lower riser pair 130. In operation, first step 122 and second step 124 sit below the panel cover and lower tread and lower riser pair 130 provides gaps and purchase for installation.

One skilled in the art will understand that the first step 122 and second step 124 will include transitions (e.g., edges) to parts of the steps (e.g., treads or risers) or surfaces of insert 100 (e.g., top edge 112, rear end 118, front end 120), that can be sharp-edged or shaped (e.g., rounded, chamfered). In the exemplary embodiment shown in FIG. 2, first step 122 includes a rounded edge. Other shapes and features can be included in first step 122 or second step 124 the steps based on various considerations, such as ease of installation, purchase to prevent a tool from slipping, and aesthetic requirements.

Insert 100 is designed in such a way with suitable dimensions and mechanical properties that one or more of first step 122, top edge 112, or second step 124 fit the panel front wall with a panel cover twistout removed. For example, one or both of first step 122 or second step 124 include a tread that fits under or behind of panel front wall. One or both of first step 122 and second step 124 include a riser that engages the periphery of a part of the panel front wall that defines a hole where a twistout had been removed. For example, FIG. 1 shows the edge of slot 31 in panel cover 15. That is, a riser faces the edge thickness of the panel front wall. In some embodiments, one or both of first step 122 and second step 124 engages the panel front wall in an interference fit.

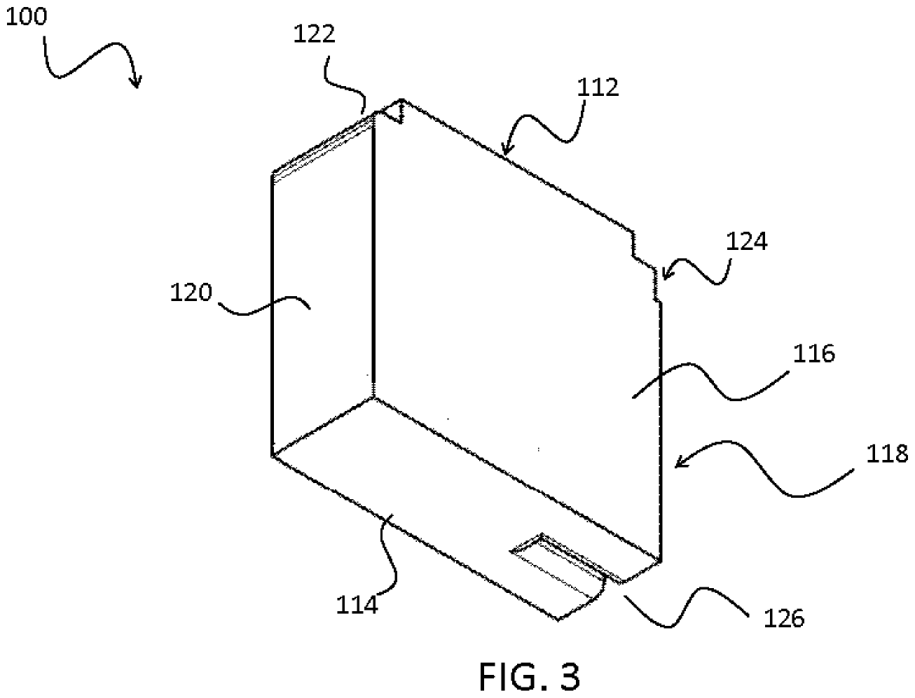

Turning to FIG. 3 which shows insert 100 in a bottom-front-left isometric view. In contrast, FIG. 2 shows Insert 100 in a top-rear-left isometric view. The transition between at least one groove 126 and bottom edge 114 or rear end 118 may be shaped—for example, rounded or chamfered. For example, as shown in FIG. 3 the transition between bottom edge 114 and at least one groove 126 is rounded. In the same example, as shown in FIG. 2, the transition between rear end 118 and at least one groove 126 is sharper than the transition between bottom edge 114 and at least one groove 126.

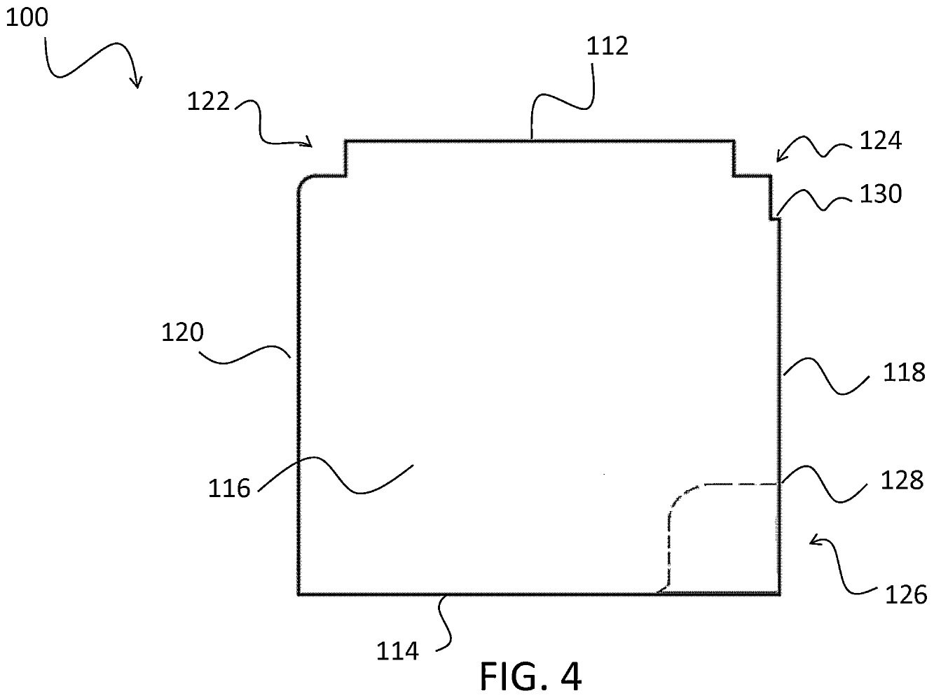

Turning to FIG. 4 which shows insert 100 in elevation view and in particular left-side view. Insert 100 includes at least one groove 126 in the bottom rear portion as defined by hidden line 128 representing a surface of insert 100 meeting the sagittal or parasagittal plane. Insert 100 may further include an indentation on side face 116 or both side face 116 and the unseen side face in FIG. 4 which provides a better grip. A side face may also be called a face.

Insert 100 may comprise a suitable insulator. In some embodiments, the insulator may be one or more plastics. Many such plastics are already known in the art, and include, for example, but are not limited to, at least one of acrylonitrile butadiene styrene (ABS), polyethylene terephthalate glycol (PETG), polycarbonate (PC), ABS/PC hybrids, electrical plastics, thermoset plastic, or thermoplastics. In some embodiments, insert 100 is hollow. Insert 100 may be a solid body. In some embodiments, insert 100 includes a solid shell and an infill pattern—e.g., triangular, rectangular, hexagonal.

In some embodiments insert 100 includes a translucent material (e.g., translucent, transparent) such as ABS, PETG, or PC. A translucent insert 100 allows the user to see the fit of insert 100 in a panel, allows for illumination of parts of the panel that would be shadowed by insert 100, and the like. In some embodiments insert 100 may include colored material or coating for safety or branding.

In another aspect, the invention provides an insert for an electrical panel that comprises a C-shaped block. Turning to FIG. 5 which shows insert 200 in isometric view and in particular bottom-front-left view analogous to FIG. 3. Insert 200 includes a generally rectangular shape (e.g., rectangular prism) with voids. Examples of voids include first step 122, second step 124, and at least one groove 126. Insert 200 includes an end void or void 202 that defines a C-shape in the elevation view of insert 200. Void 202 is defined by a plurality of surfaces such as surface 204, surface 206, and so on. Surface 204 is adjacent to first step 122 and the final surface defining void 202 is next to front end 120, or a lower part of front end 120.

Insert 200 includes top edge 112, bottom edge 114, (left) side face 116, right side face (not shown), rear end 118, and front end 120. In some embodiments, insert 200 includes the largest area in the sagittal plane and the areas in the coronal and transverse planes are about equal. Insert 200 includes first step 122 and second step 124.

In some embodiments, insert 200 includes a bulge or a knee 220 that provides material to define at least one groove 126. Knee 220 is near the bottom part of rear end 118 and rear part of bottom edge 114. In some implementations, knee 220 adds strength to insert 200.

FIG. 6 is a top-front-left isometric view of insert 200. As shown void 202 is defined by a plurality of surfaces, such as surface 208, surface 210, surface 212, and surface 214. Surfaces 206 to 214 (even numbers only) may collectively be referred to as an inner surface. In some embodiments, insert 200 includes side face 116 with a C-shape or a reverse C shape depending on the side viewed.

Insert 200 includes a trunk 232 near rear end 118, a top arm 234 near top edge 112, and a bottom arm 236 near bottom edge 114. The top arm 234 is coupled to the rear end 118 through a part of the insert 200 near second step 124. The bottom arm 236 is coupled to the rear end 118 through knee 220.

As shown in FIG. 6 insert 200 includes a top arm 234, a bottom arm 236, and a trunk 232 coupling top arm 234 and bottom arm 236. Insert 200 further includes top edge 112, bottom edge 114, a pair of sides (e.g., side face 116), rear end 118, and an inner face (e.g., surface 204, surface 206) running from the top arm 234 to the bottom arm 236. Top edge 112 defines part of top arm 232, and bottom edge 114 defines part of bottom arm 236. The inner face defines part of top arm 234, bottom arm 236, and trunk 232. Insert 200 further includes a groove (not shown see at least one groove 126) that extends from rear end 118 into trunk 232 and to bottom edge 114. The groove can be described as extending from bottom edge 114 to rear end 118. The groove, such as at least one groove 126 is a groove, as in a channel, indentation, or trench, and not a tunnel or passageway.

Insert 200 may further include a curvilinear portion comprising the inner face (e.g., surface 204, surface 206) running from the top arm 234 to the bottom arm 236. This would enable grabbing of the insert between fingers, holding and generally gripping while inserting into or removing from the electrical panel. Insert 200 may also be hooked onto clothing or a toolbelt.

The insert 200 is similar to insert 100 described herein in certain aspects. For example, insert 200 may have similar dimensions as insert 100, be made of similar materials, and include at least one groove 126. In some embodiments, insert 200 functions in a similar way to insert 100. For example, at least one groove 126 engages a bus bar in an interference fit and insert 200 fits under the panel front wall when a panel cover twistout is removed.

In some embodiments, insert 200 has a length from front end 120 to rear end 118 of about 2.75 inches or 69.85 mm. In some embodiments, insert 200 has a length from the top riser in the first step 122 to the top riser in the second step of about 2.22 inches or 56.39 mm. In some embodiments, insert 200 has a height from bottom edge 114 to top edge 112 of about 2.6 inches or 60.04 mm. In some embodiments, the bottom tread of second step 124 sits shy of top edge 112 by about 0.45 inches or 11.43 mm.

In some embodiments, at least one groove 126 is a single groove. In some embodiments, the single groove has a height of about 0.89 inches or 22.61 mm. In some embodiments, the single groove has a width of about 0.1 inches or 2.54 mm. In some embodiments, the single groove has a length of about 0.7 inches or 17.78 mm.

Turning to FIG. 7 which shows insert 300 in isometric view and in particular top-rear-left view analogous to FIG. 2. Insert 300 includes a generally rectangular shape with voids such as first step 122, second step 124, at least one groove 126, and void 202. Insert 300 differs from insert 100 and insert 200 in that side face 116 includes a void defined in part by web 302. Web 302 is a structural part of insert 300 analogous to a web in an I-beam. The analogous flanges are the parts of insert 300 near top edge 112 and bottom edge 114.

Insert 300 includes top edge 112, bottom edge 114, (left) side face 116, right side face (not shown), rear end 118, and front end 120. Insert 300 includes first step 122 and second step 124. In some embodiments, the side faces, such as side face 116, do not include the surface of web 302.

Turning to FIG. 8 which shows insert 300 in elevation view and in particular rear view. As shown, insert 300 includes web 302, a first void 304, and a second void 306. Void 304 and void 306 may be referred to as side voids in contrast to void 202 which may be called an end void. First, void 304 and second void 306 are on either side of web 302. At least one groove 126 is disposed in web 304. Insert 300 includes side face 308 the counterpart to side face 116. In some embodiments, void 304 and void 306 define flanges of uniform thickness with respect to distance from web 302 also known as W-Section. In some embodiments, void 304 and void 306 define flanges of varying thicknesses. For example, declining thickness with increasing distance from web 302 also known as S-Section.

In some embodiments, one or more of web 302, void 304, and void 306 provide additional features. In some embodiments, an insert includes only one side void, for example, only void 304. The insert 300 including void 304 and void 304 provides an indentation (e.g., dimple) on either side of the insert 300 which provides a better grip. The web 302 may include a mark (e.g., stamp, print, thickness variations, or passageways(s)) denoting the manufacturer's information, promotional information (e.g., logo), or a certification mark from one or more standards development organizations such as the American National Standards Institute (ANSI), American Society of Mechanical Engineers (ASME), American Society of Sanitary Engineering (ASSE), American Society for Testing and Materials (ASTM) International, British Electrotechnical Approvals Board (BEAB), Canadian Standards Association (CSA) Group, Certification and Accreditation Administration of the People's Republic of China (CNCA), Department for Business, Energy and Industrial Strategy (BEIS), Directorate General for Internal Market, Industry, Entrepreneurship and SMEs of the European Commission, National Sanitation Foundation (NSF) International, Norma Oficial Mexicana (NOM), and Underwriters Laboratory (UL) who provide marks such as CCC, CE, CSA, UKCA, and UL Listed. It is believed the ability to see a certification mark defined in web 302 as implemented by one or more changes in opacity, changes in thickness, or passageways imbues confidence in the product and, it is believed, generates demand.

Insert 300 is similar to one or both of insert 100 and insert 200 described herein. For example, insert 300 may have similar dimensions or be made of similar materials. In some embodiments, insert 100, insert 200, or insert 300 function in similar ways. For example, at least one groove 126 engages a bus bar in an interference fit and fits under the panel front wall when the knockout is removed.

In a preferred implementation, an insert (e.g., insert 100, insert 200, and insert 300) has dimensions such that the body is 2.75 inches in length between the pair of ends (e.g., front end 120, rear end 118), 2.6 inches in height between the edges in the pair of edges (e.g., top edge 112, bottom edge 114), and 0.98 inches in width between the faces in the pair of faces (e.g., side face 116, side face 306). In some preferred embodiments, one or more inserts (e.g., insert 100, insert 200, and insert 300) are sold with an electrical panel instead of or in addition to a filler plate. Some embodiments include an electrical product including an electrical panel such as shown in FIG. 1 and at least one insert such as those described herein. In some embodiments, an insert (e.g., insert 100, insert 200, and insert 300) is a separate article sold or given away individually or in a plurality.

FIG. 9 is a top-front-left isometric view of an insert 400. As shown insert 400 includes a void or recess 202 defined by a plurality of surfaces and interrupted by a web 402. The web 402 defines at least one cavity 404. In some embodiments, insert 400 includes, as a void, groove 126. In some embodiments, insert 400 includes other voids described herein.

Insert 400 includes a body as defined by top edge 112, bottom edge 114, and rear end 118. Web 402 spans some of the space between top edge 112, bottom edge 114, and rear end 118. In some embodiments, web 402 is defined in part by the parts of insert 400 that define groove 126. Web 402 may be positioned on center or off center, and coplanar with the sagittal plane or not. In some embodiments, web 402 extends in the anteroposterior direction over more than half of the insert 400 in the anteroposterior direction.

In some embodiments, insert 400 includes at least one cavity 404 defined in part by web 402. In some embodiments, insert 400 includes a corresponding cavity on the reverse side to the at least one cavity 404. In some embodiments, the at least one cavity 404 is defined by parts of parts of insert 400 that define groove 126.

In embodiments, web 402 may include a mark denoting the manufacturer's information, promotional information, image, or a certification mark from one or more standards development organizations as described herein.

In some embodiments, insert 400 includes a plurality of steps such as first step 122 and second step 124. In some embodiments, insert 400 has dimensions as described herein. In some embodiments, insert 400 includes materials as described herein.

FIG. 10 is a top-front-left isometric view of insert 500. As shown void 202 is defined by a plurality of surfaces 206 that may be referred to as an inner surface. In some embodiments, insert 500 includes side face 116 with a C-shape or a reverse C shape depending on the side viewed.

Insert 500 further includes top edge 112, bottom edge 114, a pair of sides (e.g., side face 116), rear end 118, and an inner surface 206. Top edge 112 defines part of top arm 232, and bottom edge 114 defines part of bottom arm 236. The inner surface 206 defines part of top arm 234, bottom arm 236, and trunk 232. In some embodiments, insert 500 includes a trunk 232 near rear end 118, a top arm 234 near top edge 112, and a bottom arm 236 near bottom edge 114. The top arm 234 and the bottom arm 236 are coupled to trunk 232.

In some embodiments insert 500 includes a web 502 between plurality of surfaces 206 and rear end 118, top edge 112, and bottom edge 114. Web 502 may be sized and positioned like web 302 or web 402. Web 502 defines in part cavity 504 shown in FIG. 10 and called out in FIG. 11.

Insert 500 includes a first set of jaws 506. The first set of jaws 506 may be on bottom edge 114 near the arris of bottom edge 114 and read end 118. In some embodiments, insert 500 includes a second set of jaws 508. In some embodiments, second set of jaws 508 is on bottom edge 114.

In some embodiments, insert 500 includes a step 510 between the sides of and ends insert 500. Step 510 is on top arm 234 at top edge 112.

Turning to FIG. 11, first set of jaws 506 includes a first jaw extending in the anteroposterior direction spaced apart in mediolateral direction from a second jaw in a corresponding orientation. In some embodiments, insert 500 includes a second set of jaws 508 including a first jaw extending in the mediolateral direction and a second jaw in corresponding orientation, spaced apart from the first jaw in the anteroposterior direction. In operation, first set of jaws 506, or second set of jaws 508, engages a member in an interference fit. For example, first set of jaws 506, or second set of jaws 508 engages a bus bar in a stab-on configuration.

Turning to FIG. 12 which shows an insert 600 in elevation view and in particular left-side view. Insert 600 includes a tab or tang 602 projecting from the insert from near the arris of read end 118 and bottom edge 114. In some embodiments, tang 602 is coplanar with the transverse plane, e.g., coplanar with bottom edge 114.

Tang 602 includes a hole 604. In some embodiments, hole 604 is in the rostral-caudal direction. That is up-down in FIG. 12 when oriented to read FIG. 12. In operation, hole 604 receives a fastener to fix insert 600 to another component such as an electrical panel. The fit between the fastener and hole 604 may be a clearance fit or an interference fit. The fastener may be connected to an electrical panel.

Insert 600 may comprise a suitable insulator. In some embodiments, the insulator may be one or more plastics described herein. Tang 604 may be a of similar or dissimilar material as insert 600 and other inserts described herein.

In some embodiments, insert 600 includes a first step 122, a second step 124, and a lower tread and lower riser pair 130.

In some embodiments, insert 600 has a length including tang 602 about 3.00 inches or 76.2 mm. In some embodiments, insert 600 has a height from bottom edge 114 to top edge 112 of about 2.91 inches or 73.91 mm. In some embodiments, insert 600 has a width of about 0.75 inches or 19.05 mm.

The present disclosure includes a set of examples.
Example 1: An insert for an electrical panel comprising an insulative block including a first edge, a second edge, a pair of sides, a first end, and a second end; and at least one void defined in the insulative block extending from the second edge into the insulative block.
Example 2: The insert of example 1, wherein the void is one of a groove, a first set of jaws, or a hole.
Example 3: The insert of example 1, wherein the void is the groove extending into the insulative block from the middle of the second end to a part of the second edge near the second end and is coplanar with the pair of sides.
Example 4: The insert of example 1, wherein the void is the first set of jaws including a first jaw extending in an anteroposterior direction spaced apart in mediolateral direction from a second jaw in a corresponding orientation.
Example 5: The insert of example 4 further comprising a second set of jaws on the second edge nearer the first end than the second end, wherein the second set of jaws includes a first jaw extending in the mediolateral direction, and a second jaw in corresponding orientation, spaced apart from the first jaw in the anteroposterior direction.
Example 6: The insert of example 1, further comprising a tab extending from an arris between the second end and second edge, and a hole defined in the tab.
Example 7: The insert of example 1, wherein the insulative block comprises a plastic selected from the group consisting of electrical plastic, thermoset plastic, and thermoplastic.
Example 8: The insert of example 7, wherein the plastic is at least one of acrylonitrile butadiene styrene (ABS), polyethylene terephthalate glycol (PETG), polycarbonate (PC), or ABS/PC hybrids.
Example 9: The insert of example 7, wherein the plastic is translucent.
Example 10: The insert of example 1 further comprising a first set of steps at a first corner between the first end and the first edge including at least one tread and at least one riser, wherein: the at least one tread is coplanar with the first edge, and the at least one riser is coplanar with the first end.
Example 11: The insert of example 10 further comprising a second set of steps at a second corner between the second end and the first edge including the at least one tread and the at least one riser, wherein: the at least one tread is coplanar with the first edge, and the at least one riser is coplanar with the second end.
Example 12: The insert of example 1 further comprising a first side cavity in the insulative block at a first side of the pair of sides; and a second side cavity in the insulative block at a second side of the pair of sides, wherein: the first side cavity, the second side cavity, the first edge, the second edge, and the second end define a flange profile, and the first side cavity, the second side cavity, and the pair of sides define a web profile.
Example 13: An insert for an electrical panel comprising a first arm; a second arm; a trunk coupling the top arm and the bottom arm; a first edge, a second edge, a pair of sides, an end, and an inner face, wherein the first edge defines a part of the first arm, and the second edge defines a part of the second arm, the inner face defines part of the first arm, the second arm, and the trunk; and a void that extends from the first edge into the trunk
Example 14: The insert of example 13, wherein the void is one of a groove, a first set of jaws, or a hole defined in the trunk.
Example 15: The insert of example 13, wherein the inner face traces a curvilinear path.
Example 16: The insert of example 13, wherein the first arm, the second arm, and the trunk comprise a plastic selected from the group consisting of electrical plastic, thermoset plastic, and thermoplastic.
Example 17: The insert of example 16, wherein the plastic is at least one of acrylonitrile butadiene styrene (ABS), polyethylene terephthalate glycol (PETG), polycarbonate (PC), or ABS/PC hybrids.
Example 18: The insert of example 16, wherein the plastic is translucent.
Example 19: The insert of example 13 further comprising a knee disposed between and coupling the trunk and the second arm, wherein the void extends from the sagittal middle and below the transverse middle the end, through the knee, to the second edge near the end.
Example 20: The insert of example 13 further comprising a first set of steps at the distal end of the first arm including at least one tread and at least one riser, wherein: the at least one tread is coplanar with the first edge and in operation engages the inside of a panel cover for the electrical panel, and the at least one riser is coplanar with the end and in operation engages the periphery of a hole in the panel for the electrical panel.
Example 21: The insert of example 13 further comprising a second set of steps at the proximal end of the first arm including at least one tread and at least one riser, wherein: the at least one tread is coplanar with the first edge and in operation engages the inside of a panel cover for the electrical panel, and the at least one riser is coplanar with the end and in operation engages the periphery of a hole in the panel for the electrical panel.
Example 22: The insert of example 13, further comprising a pair of side cavities reducing the mass of the first arm, the second arm, and the trunk, wherein in profile in either the coronal plane or the transverse plane at least one of the first arm, the second arm, and the trunk has an I-beam profile.
Example 23: An electrical product comprising an electrical panel and at least one insert of any of examples 1 to 22.

The orientations provided such as top-bottom, front-rear, and left-right correspond to how inserts (e.g., insert 100, insert 200, insert 300, insert 400, insert 500, and insert 600) are shown in FIGS. 2 through 12. These directions also define the coronal, sagittal, and transverse planes used herein, and directions like lateral. However, when used in an electrical panel the directions change. The ends, previously front or rear, become left or right. The sides, previously left or right, become up or down. And the edges, previously top or bottom, become front or back respectively.

While only certain features of the invention have been illustrated and described herein, those skilled in the art will recognize many changes or modifications are possible for the disclosed embodiments or implementations. It is, therefore, to be understood that the appended claims are intended to cover all such modifications and changes as fall within the true spirit of the invention.

1. An insert for an electrical panel comprising:
a. an insulative block including a first edge, a second edge, a pair of sides, a first end, and a second end; and
b. at least one void defined in the insulative block extending from the second edge into the insulative block.

2. The insert of claim 1, wherein the void is one of a groove, a first set of jaws, or a hole.

3. The insert of claim 1, wherein the void is the groove extending into the insulative block from the middle of the second end to a part of the second edge near the second end and is coplanar with the pair of sides.

4. The insert of claim 1, wherein the void is the first set of jaws including a first jaw extending in an anteroposterior direction spaced apart in mediolateral direction from a second jaw in a corresponding orientation.

5. The insert of claim 4 further comprising a second set of jaws on the second edge nearer the first end than the second end, wherein the second set of jaws includes
a. a first jaw extending in the mediolateral direction, and
b. a second jaw in corresponding orientation, spaced apart from the first jaw in the anteroposterior direction.

6. The insert of claim 1, further comprising a tab extending from an arris between the second end and second edge, and a hole defined in the tab.

7. The insert of claim 1, wherein the insulative block comprises a plastic selected from the group consisting of electrical plastic, thermoset plastic, and thermoplastic.

8. The insert of claim 7, wherein the plastic is at least one of acrylonitrile butadiene styrene (ABS), polyethylene terephthalate glycol (PETG), polycarbonate (PC), or ABS/PC hybrids.

9. The insert of claim 7, wherein the plastic is translucent.

10. The insert of claim 1 further comprising a first set of steps at a first corner between the first end and the first edge including at least one tread and at least one riser, wherein:
a. the at least one tread is coplanar with the first edge, and
b. the at least one riser is coplanar with the first end.

11. The insert of claim 10 further comprising a second set of steps at a second corner between the second end and the first edge including the at least one tread and the at least one riser, wherein:
a. the at least one tread is coplanar with the first edge, and
b. the at least one riser is coplanar with the second end.

12. (canceled)

13. An insert for an electrical panel comprising:
a. a first arm;
b. a second arm;
c. a trunk coupling the top arm and the bottom arm;
d. a first edge, a second edge, a pair of sides, an end, and an inner face, wherein the first edge defines a part of the first arm, and the second edge defines a part of the second arm,
e. the inner face defines part of the first arm, the second arm, and the trunk; and
f. a void that extends from the first edge into the trunk

14. The insert of claim 13, wherein the void is one of a groove, a first set of jaws, or a hole defined in the trunk.

15. The insert of claim 13, wherein the inner face traces a curvilinear path.

16. The insert of claim 13, wherein the first arm, the second arm, and the trunk comprise a plastic selected from the group consisting of electrical plastic, thermoset plastic, and thermoplastic.

17. The insert of claim 16, wherein the plastic is at least one of acrylonitrile butadiene styrene (ABS), polyethylene terephthalate glycol (PETG), polycarbonate (PC), or ABS/PC hybrids.

18. (canceled)

19. (canceled)

20. The insert of claim 13 further comprising a first set of steps at the distal end of the first arm including at least one tread and at least one riser, wherein:
a. the at least one tread is coplanar with the first edge and in operation engages the inside of a panel cover for the electrical panel, and
b. the at least one riser is coplanar with the end and in operation engages the periphery of a hole in the panel for the electrical panel.

21. The insert of claim 13 further comprising a second set of steps at the proximal end of the first arm including at least one tread and at least one riser, wherein:
a. the at least one tread is coplanar with the first edge and in operation engages the inside of a panel cover for the electrical panel, and
b. the at least one riser is coplanar with the end and in operation engages the periphery of a hole in the panel for the electrical panel.

22. The insert of claim 13, further comprising a pair of side cavities reducing the mass of the first arm, the second arm, and the trunk, wherein in profile in either the coronal plane or the transverse plane at least one of the first arm, the second arm, and the trunk has an I-beam profile.

23. An electrical product comprising an electrical panel and at least one insert of claim
